(19) United States
(12) Patent Application Publication
(10) Pub. No.: US 2015/0077232 A1
(43) Pub. Date: Mar. 19, 2015

(54) NEAR FIELD COMMUNICATION DEVICES FOR MERCHANDISE SECURITY

(71) Applicant: InVue Security Products Inc., Charlotte, NC (US)

(72) Inventors: Jeffrey A. Grant, Charlotte, NC (US); Gary A. Taylor, Fort Mill, SC (US); David N. Berglund, Charlotte, NC (US)

(21) Appl. No.: 14/487,471

(22) Filed: Sep. 16, 2014

Related U.S. Application Data
(60) Provisional application No. 61/878,667, filed on Sep. 17, 2013.
(60) Provisional application No. 61/883,282, filed on Sep. 27, 2013.

(51) Int. Cl. G07C 9/00; G08C 17/00; G08C 19/12

(52) U.S. Cl. CPC G07C 9/00309; G08C 19/12; G08C 17/00; G07C 2009/00325; G07C 2009/0019
USPC 340/13.24

(57) ABSTRACT

Embodiments of the invention are directed to merchandise security devices, systems, and methods for protecting an item of merchandise from theft. For example, a merchandise security device may include an electronic lock configured for securing the merchandise security device to a merchandise fixture. The electronic lock has at least one near field communication (“NFC) tag configured to communicate with an electronic device having at least one NFC tag for at least unlocking the electronic lock of the merchandise security device.

### CROSS REFERENCE To RELATED APPLICATIONS

This application claims the benefit of priority to U.S. Provisional Application No. 61/878,667 filed on Sep. 17, 2013, and U.S. Provisional Application No. 61/883,282 filed on Sep. 27, 2013, the entire disclosures of which are incorporated herein by reference.

### FIELD OF THE INVENTION

Embodiments of the invention relate generally to security devices, systems, and methods for protecting an item of merchandise from theft. More particularly, embodiments of the invention relate to security devices, systems and methods including near field communication (“NFC”) functionality for merchandise security.

### BACKGROUND OF THE INVENTION

It is common practice for retailers to store and/or display relatively expensive items of merchandise on or within a merchandise security device, such as a security display (e.g. alarming stand), security fixture (e.g. locking hook, shelf, cabinet, etc.) or security packaging (e.g. merchandise keeper). Regardless, the security device stores and/or displays an item of merchandise so that a potential purchaser may view, and in some instances, interact with the item before making a decision whether to purchase the item. At the same time, the item is secured on or within the merchandise security device so as to prevent, or at least deter, theft of the item. The value of the item, however, may make it an attractive target for a shoplifter despite the presence of a merchandise security device. A determined shoplifter may attempt to detach the item from the security display or to remove the item from the security fixture or from within the security packaging. Alternatively, the shoplifter may attempt to remove all or a portion of the security device from the display area along with the item of merchandise.

In the case of a security fixture, and in particular a merchandise display cabinet or drawer, the merchandise security device is oftentimes locked with a lock to prevent merchandise from being removed from the cabinet or drawer without the assistance of an authorized person, such as a sales associate. In most instances, the lock includes a conventional tumbler or spring-biased lock mechanism operated by a non-programmable, manually operated mechanical or magnetic key. Too often, however, a mechanical or magnetic key is lost, stolen or damaged. A mechanical key can also break off in the lock and/or damage the lock mechanism of the lock. In certain instances, the merchandise security device is secured by a lock including a lock mechanism that is operated by a merchandise security key in the form of a programmable electronic key. However, a programmable electronic key can likewise be lost, stolen or damaged. Accordingly, there is a need for an electronic key that operates an electronic lock and is less susceptible to being lost, stolen or damaged.

### SUMMARY OF THE INVENTION

In one aspect, the invention is embodied by a merchandise security device for protecting an item of merchandise from theft. The merchandise security device includes an electronic lock configured to be locked or unlocked and to be secured to a merchandise fixture. The electronic lock has at least one near field communication (“NFC”) tag that is configured to communicate with an electronic device having at least one NFC tag to unlock the electronic lock.

In one embodiment, the electronic lock may include a lock mechanism configured to be actuated between a locked position and an unlocked position in response to communication between the at least one NFC tag of the electronic lock and the at least one NFC tag of the electronic device. In another embodiment, the electronic lock may further include a processor in communication with a switch. The processor may be configured to actuate the switch to thereby actuate the lock mechanism in response to communication with the at least one NFC tag of the electronic device.

In another embodiment, the lock mechanism may include an actuator that is configured to extend and retract in response to communication between the at least one NFC tag of the electronic lock and the at least one NFC tag of the electronic device. In another embodiment, the electronic lock may further include a source of electrical power. In yet another embodiment, the electronic lock may further include a proximity mechanism configured to detect the position of the electronic lock relative to the merchandise fixture. The proximity mechanism may be a reed switch or a Hall effect sensor.

In another aspect, the invention is embodied by a merchandise security system including an electronic lock configured to locked or unlocked and to be secured to a merchandise fixture. The electronic lock has at least one near field communication (“NFC”) tag. The merchandise security system further includes an electronic device having at least one NFC tag. The at least one NFC tag of the electronic lock is configured to communicate with the at least one NFC tag of the electronic device to unlock the electronic lock.

In one embodiment, the electronic device is a mobile phone or a Smartphone. In another embodiment, the electronic lock is a drawer lock or a locking hook.

In yet another embodiment, the electronic lock includes a lock mechanism configured to be actuated between a locked position and an unlocked position in response to communication between the at least one NFC tag of the electronic lock and the at least one NFC tag of the electronic device. In yet another embodiment, the electronic lock comprises a processor in communication with a switch, the processor being configured to actuate the switch to thereby actuate the lock mechanism in response to communication with the at least one NFC tag of the electronic device. In another embodiment, the electronic lock further includes a source of electrical power. In still another embodiment, the electronic lock further includes a proximity mechanism configured to detect the position of the electronic lock relative to the merchandise fixture.

In yet another aspect, the invention is embodied by a method for protecting merchandise from theft. The method includes attaching an electronic lock to a merchandise fixture, the electronic lock is configured to be locked or unlocked and to includes at least one near field communication (“NFC”) tag. The method further includes actuating an electronic key comprising at least one NFC tag such that the at least one NFC tag of the electronic lock communicates with the at least one NFC tag of the electronic device to unlock the electronic lock.

In yet another aspect, the invention is embodied by a method for protecting merchandise from theft. The method includes communicating data between an electronic lock and an electronic device via near field communication (“NFC”). The method further includes actuating the electronic lock in response to receiving the data such that the electronic lock is unlocked and the item of merchandise is accessible to an authorized person.

### BRIEF DESCRIPTION OF THE DRAWING FIGURES

The detailed description of the invention provided below may be better understood with reference to the accompanying drawing figures, which depict embodiments of merchandise security devices and systems that utilize near field communication (“NFC”) functionality.

FIG. 1 is a perspective view showing an embodiment of a merchandise security device according to the invention including an electronic lock and an electronic device configured for unlocking the electronic lock.

FIG. 2 is a top view showing the electronic lock of FIG. 1.

FIG. 3 is a rear view showing the electronic lock of FIG. 1 in an unlocked configuration.

FIG. 4 is a rear view showing the electronic lock of FIG. 1 in a locked configuration.

FIG. 5 is a schematic illustrating various components of the electronic device of FIG. 1.

FIG. 6 is a schematic showing various components of the electronic lock of FIG. 1.

FIG. 7 is a perspective view showing another embodiment of a merchandise security device according to the invention including an electronic lock.

FIG. 8 is a partial perspective view showing a forward end portion of the merchandise security device of FIG. 7.

FIG. 9 is a partial perspective view showing various components of the merchandise security device of FIG. 7.

FIG. 10 is a partial perspective view showing various components of the electronic lock of the merchandise security device of FIG. 7.

FIG. 11 is an exploded perspective view showing various components of the merchandise security device of FIG. 7.

FIG. 12 is a perspective view showing another embodiment of a merchandise security device according to the invention including an electronic lock and an electronic device for unlocking the electronic lock.

FIG. 13 is a perspective view showing the electronic lock of FIG. 12 in an unlocked configuration for removing items of merchandise from the merchandise security device.

### DETAILED DESCRIPTION OF EMBODIMENTS OF THE INVENTION

Referring now to the accompanying drawing figures wherein like reference numerals denote like elements throughout the various views, one or more embodiments of a merchandise security device and system are shown. Embodiments of the invention include an electronic lock and electronic device that utilize near field communication (“NFC”) functionality. A merchandise security device and system according to embodiments of the invention is operable for use with a merchandise fixture that stores and/or displays merchandise, for example, in a retail store. In the embodiments shown and described herein, a merchandise security device, indicated generally at 10, includes an electronic lock, indicated generally at 12, and an electronic device, indicated generally at 14, configured for at least unlocking a merchandise fixture, indicated generally at 15.

An embodiment of a merchandise security device 10 according to the invention is illustrated in FIGS. 1-6. The merchandise security device 10 depicted therein is operable for use with a merchandise fixture 15, for example a merchandise drawer adapted for storing and protecting items of merchandise disposed within the drawer. The drawer 15 may be operably engaged with a table, cabinet, desk, or other support structure 16 that allows the drawer to be moved into and out of engagement with the support structure. The drawer 15 may include a handle 18 for allowing a user to pull the drawer away from the support structure 16 to access to an item of merchandise, and to push the drawer 15 towards the support structure 16 for preventing access to an item of merchandise when the drawer 15 is in a closed and locked configuration. Although the illustrated embodiments are discussed for use with a drawer, it should be noted that the invention is applicable to any number of merchandise fixtures, such as merchandise display cabinets, doors, or the like that utilize a locking mechanism.

In some embodiments, the electronic lock 12 and the electronic device 14 are similar to those disclosed in U.S. Patent Publication No. 2013/0081434, entitled Cabinet Lock for Use with Programmable Electronic Key and filed Sep. 28, 2012, U.S. Patent Publication No. 2012/0047972, entitled Electronic Key for Merchandise Security Device and filed Aug. 31, 2011, and U.S. Patent Publication No. 2011/0254661, entitled Programmable Security System and Method for Protecting Merchandise and filed Jun. 27, 2011, each disclosure of which is incorporated by reference herein in its entirety. In other embodiments, the electronic lock 12 and the electronic device 14 are similar to those manufactured by InVue Security Products Inc., including Drawer Locks, Plunger Locks, Smart Locks, and IR2 and IR2-S Keys.

In one embodiment, a hand-held electronic device 14, such as a Smartphone or mobile phone, is configured to function as a non-mechanical, contactless key for locking and/or unlocking the merchandise security device 10. The electronic device 14 may include various components known to those skilled in the art (see, e.g., FIG. 5), such as, for example, a housing 14A, a controller or processor 14B disposed within the housing, a display 14C disposed on the housing and coupled to the processor, a power source 14D for powering the device, wireless communication functionality 14E, an internal memory (not shown), a SIM card and/or SM card (not shown), a camera (not shown), a speaker (not shown), and/or a user interface (not shown). The power source 14D may be a multiple-use internal power source, such as a conventional capacitor or rechargeable battery. The electronic device 14 may also include various functionality for generating a security signal, such as alarm means for generating an audible alarm (e.g., a piezoelectric alarm), display 14C for providing a visible alarm message on the display, means for generating a haptic signal (e.g., vibration), and/or means for terminating the article's functionality (e.g., code for shutting the power off and rendering input devices inoperable).

As previously mentioned, the electronic device 14 comprises near field communication (“NFC”) functionality, such as one or more NFC tags 14F, chips, or stickers, for facilitating NFC communication. In this regard, the electronic device 14 may communicate with other devices via NFC to transmit data when the devices are positioned near one another or in direct contact with one another. Each NFC tag 14F may have an antenna for effectuating NFC communication with another device. NFC functionality may be integrated into the electronic device 14 or may be added on, such as via a SIM card or micro SD card having an NFC tag 14F.

In one embodiment shown and described herein, the electronic device 14 may include NFC functionality in the form of one or more NFC tags 14F that are configured to communicate with one or more NFC tags associated with a drawer lock 12. Thus, the NFC tags may be configured to communicate wirelessly with one another to thereby lock and/or unlock the drawer lock 12. The NFC tags may be configured to recognize one another such that only particular NFC tags are programmed to communicate with one another. For example, the NFC tag associated with the drawer lock 12 may be configured to read the data on the NFC tag 14F of the electronic device 14. The NFC tags may be programmed in any suitable manner to include data that allows the drawer lock 12 and the electronic device 14 to communicate with one another and to recognize one another. In some embodiments, the NFC tags may include a security code or identifier, and the drawer lock 12 may be programmed with the same security code or identifier. In the event that the security code of the electronic device 14 matches the security code of the drawer lock 12, the drawer lock is then operated to actuate the lock mechanism to an unlocked configuration. It is understood that the NFC tags of the electronic device 14 and the drawer lock 12 may be active or passive and that the term “tag” is meant to be interpreted broadly, as the tag may be a chip, sticker, or circuit that includes NFC functionality.

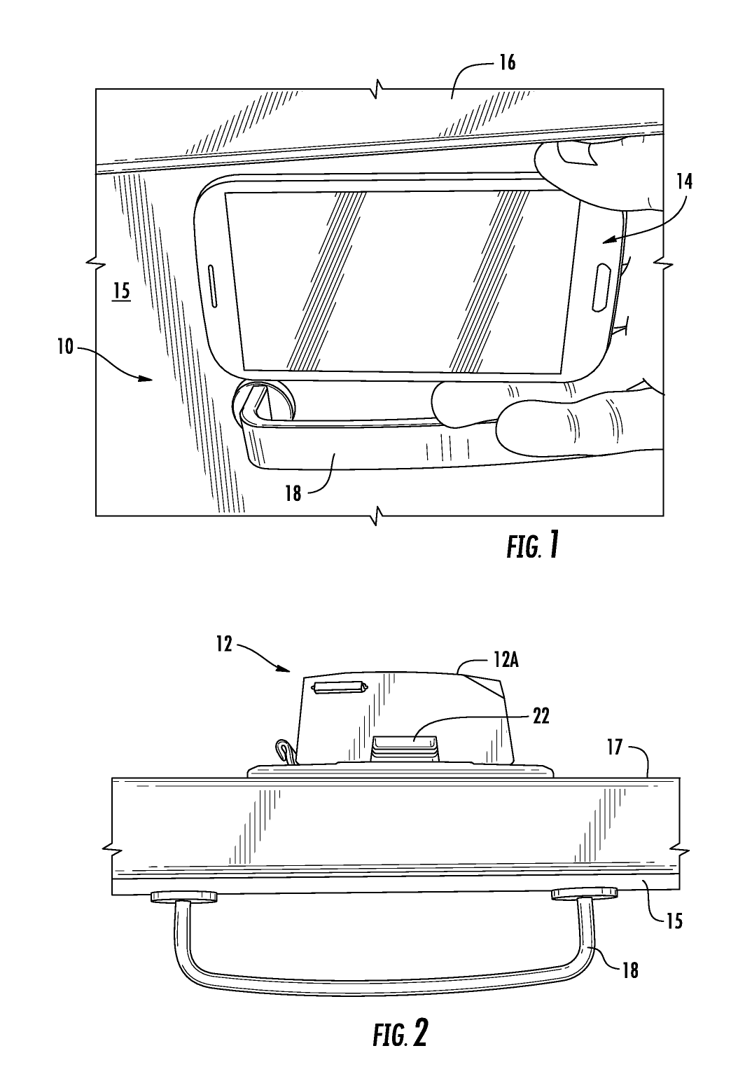

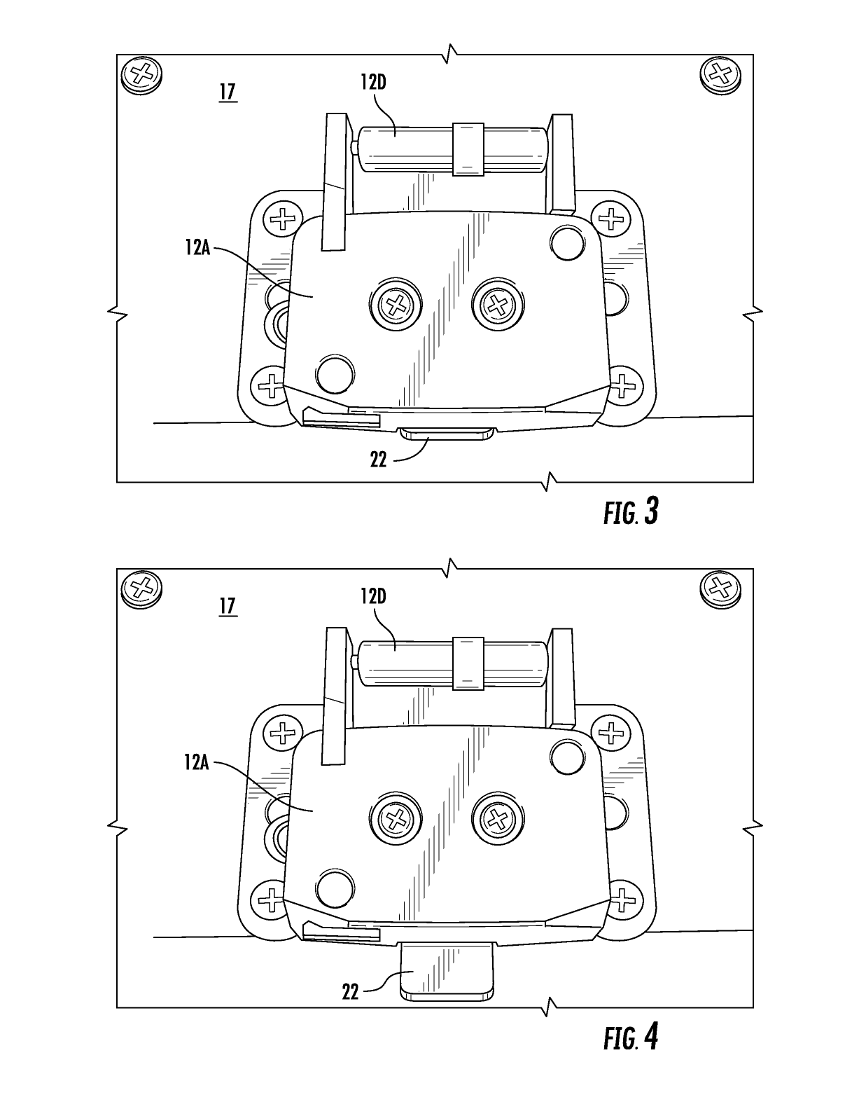

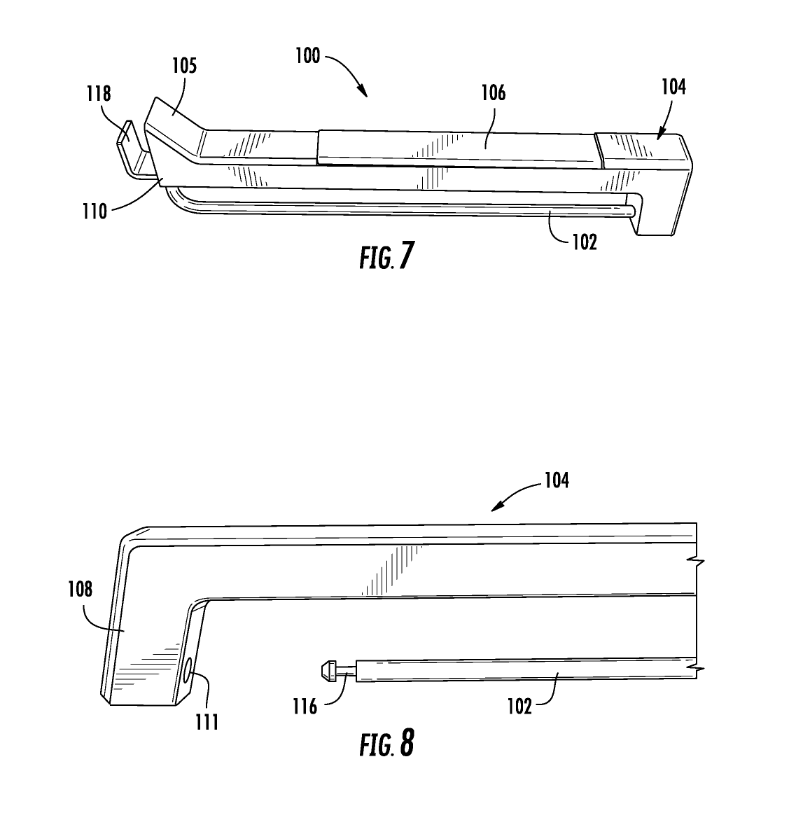

The drawer lock 12 may include a housing 12A that is configured to contain a variety of components. The housing 12A may be secured to the drawer 15 using any desired technique, such as fasteners and/or adhesives. As shown in FIG. 2, for example, the housing 12A is fastened to an inner surface 17 of the drawer 15 so as to be inaccessible when the drawer is in a closed position. The housing 12A may contain a controller or processor 12B that is in communication with one or more NFC tags 12F and a lock mechanism 12C (see, e.g., FIG. 6). The drawer lock 12 may further include a switch 12E that is in communication with the processor 12B. The processor 12B may be configured to activate the switch 12E to thereby actuate the lock mechanism 12C in response to receiving a signal from the NFC tag 14E of the electronic device 14. Therefore, upon detecting an authorized NFC tag 14E, the processor 12B is configured to actuate the switch 12E. The drawer lock 12 may also contain an internal source of electrical power, such as a battery 12D. However, in other embodiments, the drawer lock 12 may not include an internal power source (e.g., battery 12D), and as such, may be “electrically passive”. In this case, the electronic device 14 may contain an internal source of electrical power 14D, such as a conventional extended-life or rechargeable battery, capacitor or the like, that is configured to transfer electrical power to the drawer lock 12 for at least the purpose of unlocking the drawer. The electronic device 14 may transfer electrical power to the drawer lock 12 in any suitable manner, such as by electrical contacts, acoustical transmission (e.g. RF signals), or magnetic induction.

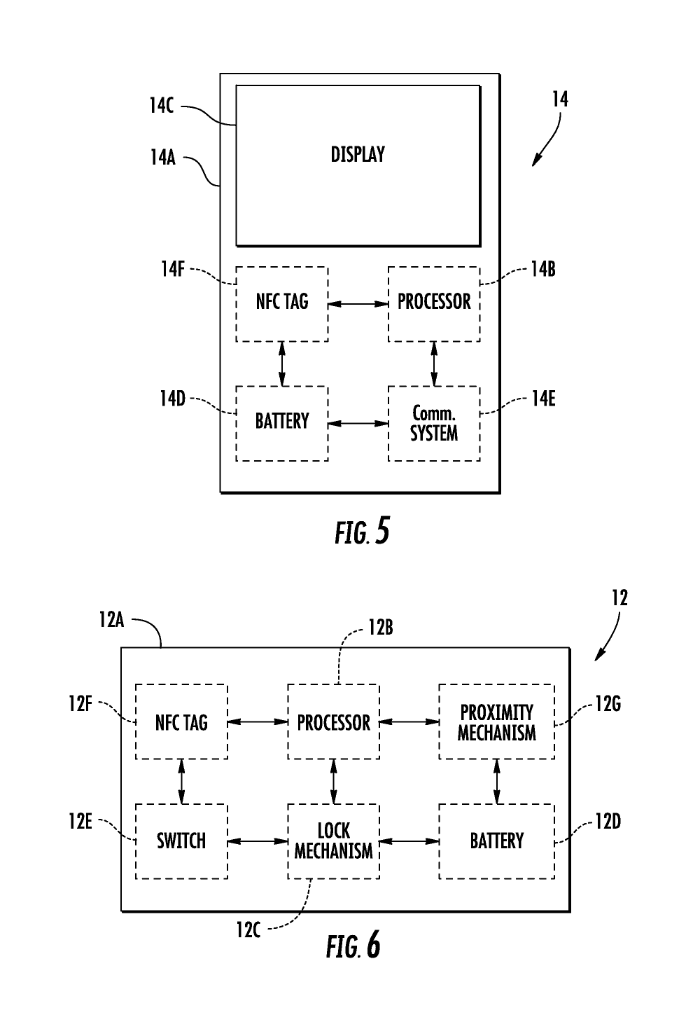

As previously mentioned, the drawer lock 12 may include a lock mechanism 12C configured to move between locked and unlocked configurations. In the illustrated embodiment, the lock mechanism 12C is a mechanical lock including an actuator 22 that is configured to move linearly between an extended position (see FIG. 4) and a retracted position (see FIG. 3). However, it is understood that the lock mechanism 12C may be any suitable mechanism that is configured to move between locked and unlocked positions, such as a plunger, cam, or the like for facilitating mechanical actuation. The drawer lock 12 may be equipped with an electric motor, DC stepper motor, solenoid, or the like, that is in communication with the processor 12B and powered by the battery 12D for actuating the lock mechanism 12C.

In some embodiments, the electronic device 14 may be configured to transfer power to the electronic lock 12 for operating the lock mechanism 12C. In one embodiment, the electronic lock 12 includes a conductor coupled to a mechanical lock mechanism 12C including an actuator 22, and when electrical power is conducted through the conductor, a state change occurs thereby resulting in operation of the lock mechanism. In one example, the conductor is coupled to a shape memory material (e.g., Nitinol) such that electrical power transferred from the electronic device 14 and through the conductor results in a change in shape of the shape memory material (e.g., contraction). Such a change in shape may cause a mechanical actuation (e.g., linear or rotary) of the actuator 22 to thereby lock or unlock the lock mechanism 12C. Examples of using such shape memory material for a lock mechanism 12C may be found, for example, in U.S. application Ser. No. 14/328,051, filed on Jul. 10, 2014, which is hereby incorporated by reference in its entirety.

The electronic device 14 is configured to at least unlock the drawer lock 12 from the locked configuration. The electronic device 14 may also place the drawer lock 12 into the locked configuration after the drawer 15 is moved to the closed position. It may be desirable that the electronic device 14 is required to both unlock and lock (or re-lock) the drawer lock 12 so that an authorized person responsible for unlocking the drawer 15 is held accountable for locking the drawer after each time his or her electronic device is used to unlock the drawer. For example, electronics disposed within the electronic device 14 may be used to assign a unique identifier corresponding to the user of the electronic device to a memory, and to thereafter record the date and time into the memory each time the electronic device 14 is used to actuate the lock mechanism 12C of the drawer lock 12. In some embodiments of the invention, a successful activation of the electronic device 14 occurs, for example, when a security code of the electronic device, for example a programmable electronic key, matches a security code assigned to the drawer lock 12.

Regardless, the electronic device 14 may be positioned near, or adjacent to, the drawer 15 for activating the drawer lock 12 via NFC communication. The electronic device 14 may be activated simply by being placed in proximity to the drawer lock 12 to thereby initiate communication between the electronic device and the drawer lock. For example, the electronic device 14 may be configured to communicate with the drawer lock 12 within a particular distance, such as, for example, within about 5 inches, within about 4 inches, within about 3 inches, within about 2 inches, or within about 1 inch. Thus, a user of the electronic device 14 may not be required to manually depress an actuator button or interact with a user interface of the electronic device. In addition, the drawer 15 does not require an interface or port for interacting with a feature of the electronic device 14 such that contactless communication between the electronic device and the drawer lock 12 may occur. As will be explained further hereafter, communication between the electronic device 14 and the drawer lock 12 in the locked configuration causes a lock mechanism 12C of the drawer lock to disengage or unlock, such that the drawer 15 is permitted to be moved (e.g., slid) relative to the support structure 16 to access the merchandise stored within the drawer.

Once the merchandise has been accessed, for example, by an authorized person, such as a sales associate, the drawer 15 may be returned to a closed position. Thereafter, the drawer lock 12 may be actuated from the unlocked configuration to the locked configuration. The drawer lock 12 may be configured to automatically lock when the drawer 15 is in a closed position, such as at a predetermined period of time after the drawer is closed. In one embodiment, the drawer lock 12 includes a proximity mechanism 12G configured to detect the position of the drawer lock relative to the support structure 16 or another stationary feature of the merchandise fixture. Thus, the proximity mechanism 12G may be configured to detect that the drawer 15 is in a closed position to thereby allow the drawer lock 12 to move from the unlocked configuration back to the locked configuration. For example, the drawer lock 12 may include a proximity mechanism 12G, such as a reed switch or a Hall effect sensor, and the support structure 16 may include a magnet. The magnet is positioned such that the proximity mechanism 12G is proximate to the magnet when the drawer 15 is in a closed position. The proximity mechanism 12G detects the magnet which provides a signal to the drawer lock 12 to move the lock mechanism 12C to the locked configuration. As such, the proximity mechanism 12G may reduce or eliminate the possibility of the drawer lock 12 inadvertently locking prior to the drawer 15 being in a closed position. Moreover, the proximity mechanism 12G may facilitate automatic locking thereby reducing the likelihood that a drawer 15 will be inadvertently left unlocked with the drawer in a closed position.

It is understood that the electronic lock 12 and electronic device 14 may include various other optional functionality in accordance with embodiments of the invention. For example, the electronic device 14 may be configured to take and record (e.g., store in memory) photographs of the drawer 15 and/or the items of merchandise when the electronic lock 12 is in an unlocked configuration and the drawer is in an open position. Moreover, the electronic device 14 may be configured to scan a barcode or UPC label of the item of merchandise contained within the drawer 15 for record keeping. Alternatively, a successful photograph or scan may be required before the item of merchandise can be removed from the drawer 15 for purchase or examination by a consumer.

Furthermore, the electronic device 14 may be configured to incorporate various “key-like” functions. In this regard, the electronic device 14 may include software that allows the device to perform various functions. For example, the electronic device 14 may be configured to open one electronic lock 12 at a time. In one embodiment, the software may require an authorized person to place the electronic device 14 proximate to a closed drawer 15 to “confirm” that the drawer lock 12 is indeed locked before the software will allow the authorized person to unlock a different drawer lock 12 having a different unique identification. The software could also provide feedback to the authorized person based on the state of the electronic lock 12, such as an audible and/or visible signal to confirm that the electronic lock has been locked or unlocked or that an error has occurred. The electronic device 14 could also be configured to provide feedback, such as via an audible and/or visible signal, to the authorized person while the drawer lock 12 is in an unlocked configuration to reduce the likelihood that the drawer lock will be inadvertently left unlocked. In another example, the electronic device 14 could be configured to provide an audible alert after a predetermined period of time to notify the user that the drawer 15 remains in an unlocked configuration. In addition, the electronic device 14 may be password protected and configured to time out after a predetermined period of time. Thus, after a predetermined period of time (e.g., 6-8 hours), an authorized person may be required to input a password into the electronic device 14 before the electronic device is able to communicate with the electronic lock 12 again.

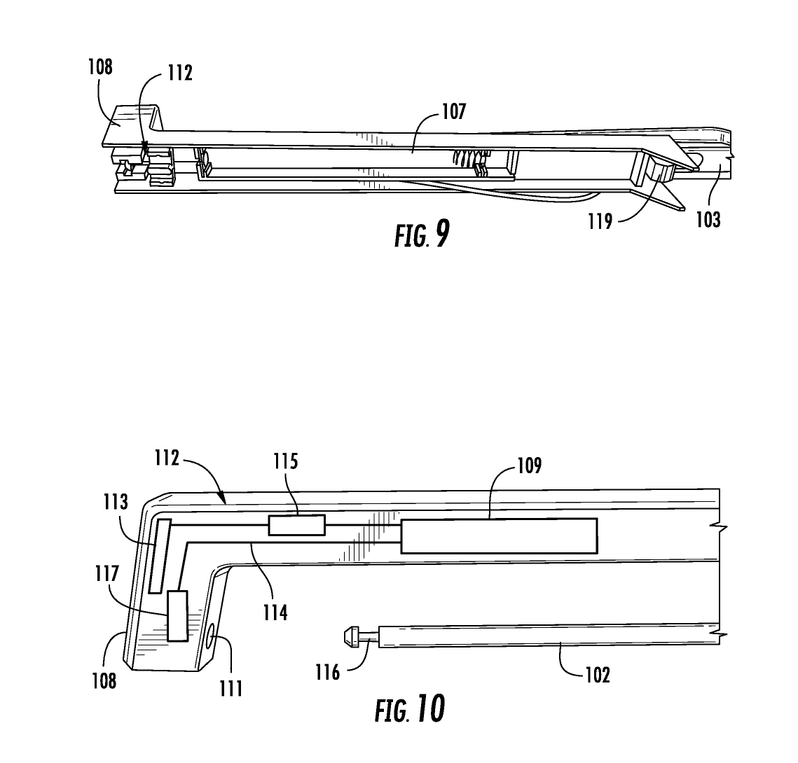

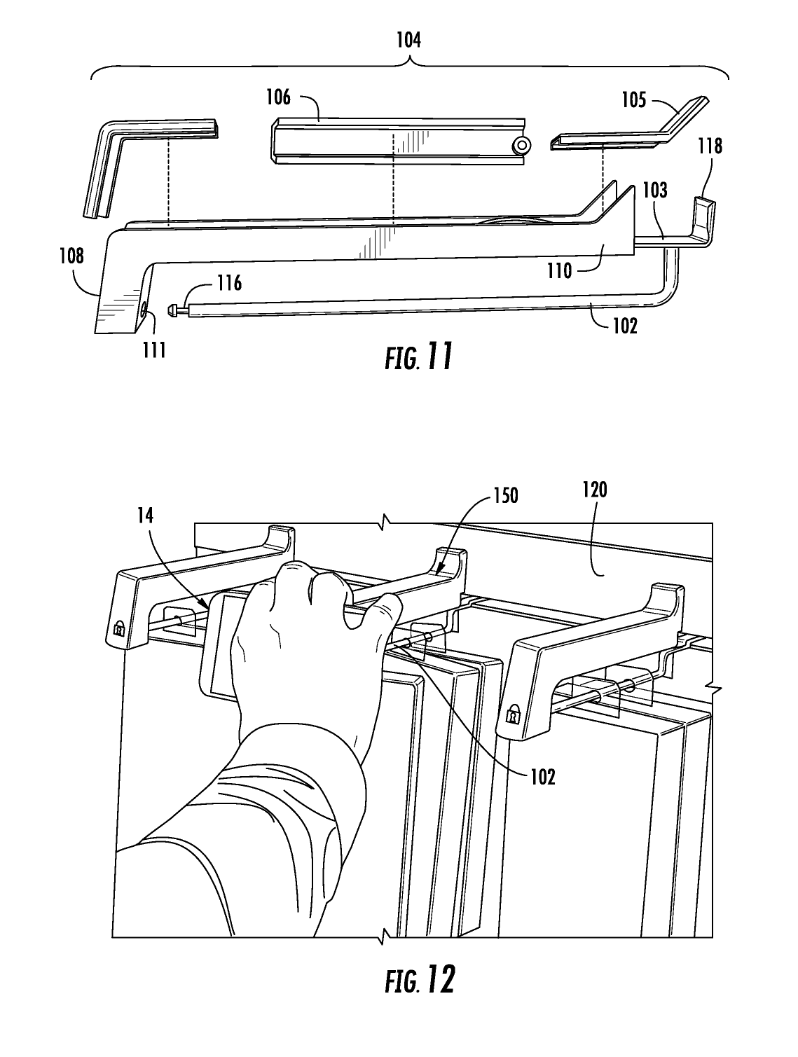

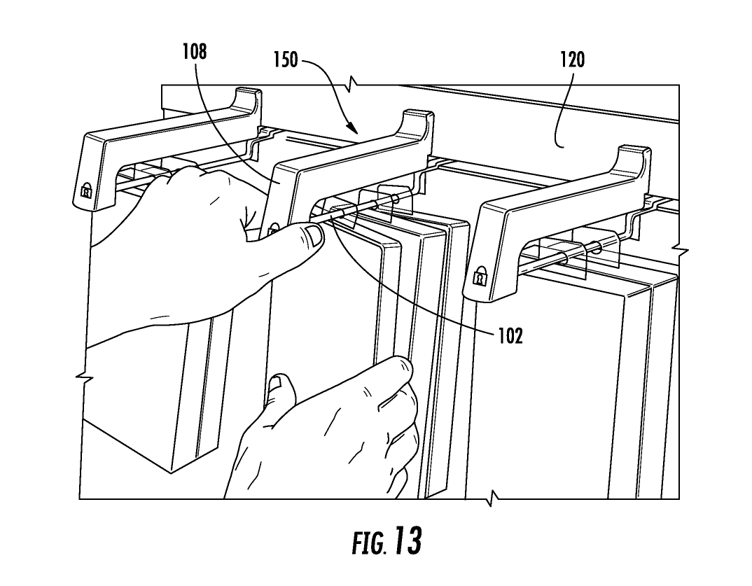

FIGS. 7-11 illustrate another embodiment of a merchandise security device 100 according to the invention. In this embodiment, an electronic lock 112 is incorporated into a locking hook 100 that is configured to releasably engage at least one elongate rod, bar, or the like. In the illustrated embodiment, the locking hook 100 comprises a pair of rods disposed generally parallel to one another such that items of merchandise may be disposed on the lower rod 102. The locking hook 100 is configured to move between a locked configuration and an unlocked configuration through engagement and disengagement with the lower rod 102. The locking hook 100 generally includes a housing 104 that is coupled to an upper rod 103. The housing 104 may be attached to the upper rod 103 such that the housing cannot be removed from the upper rod, although the housing may be configured to move relative to the upper rod (e.g., via sliding action). The housing 104 may have a multi-component configuration wherein the housing includes a plurality of components that may be assembled together (see, e.g., FIG. 11). One of the components may be a removable cover 106 (see, e.g., FIG. 7) for accessing a battery compartment 107 (see, e.g., FIG. 9) that houses a power source, such as one or more batteries 109 (see, e.g., FIG. 10). The housing 104 may include a forward end portion 108 that is configured to engage a free end of the lower rod 102, and a rear end portion 110 that is configured to engage or be proximate to a merchandise fixture 120 (see, e.g., FIG. 12), such as a display surface (e.g., pegboard, slatwall or the like), with an engagement member 118.

The forward end portion 108 may include an opening 111 sized and configured to receive an end of the lower rod 102. The rear end portion 110 may be configured to resist manipulation of the looking hook when in a locked position. In this regard, the rear end portion 110 may include an angled protrusion 105 that is configured to be proximate to or abut the display surface 120 with the locking hook 100 engaging the display surface. Thus, should an unauthorized person attempt to pivot the locking hook 100 upwardly relative to the display surface 120, the angled protrusion 105 will engage the display surface and resist further pivoting movement. Although illustrated as a multi-component housing, it is understood that the housing 104 may be a single integrally molded component or any number of components if desired. Moreover, the housing 104 may be sized to engage along substantially the entire length of the upper rod 103, or may extend only partially along the length of the upper rod in some embodiments. Furthermore, the lower rod 102 and the upper rod 103 may have various sizes and configurations. For example, the lower rod 102 may have a circular cross section, while the upper rod 103 may have a generally L-shaped cross section. In addition, the lower rod 102 and the upper rod 103 may have the same or different configurations according to various embodiments of the invention.

The locking hook 100 includes an electronic lock 112 that is configured to interact with an electronic device 14 having NFC functionality (see, e.g., FIG. 12). In one embodiment illustrated in FIG. 10, the electronic lock 112 includes an NFC tag 113 that is configured to communicate with a controller or processor 115. Upon communication with an authorized electronic device 14 utilizing NFC, the processor 115 is configured to actuate an electronic lock mechanism 117. For example, the lock mechanism 117 may include a shape memory material 114 (e.g., Nitinol) that is in electrical communication with a power source 109 (e.g., a battery). The lock mechanism 117 may also include an engagement member coupled to the shape memory material 114 that is configured to engage with the lower rod 102, for example a pin, that engages a notch 116 formed in the lower rod. The processor 115 is configured to provide electrical power from the battery 109 to the shape memory material 114 to thereby cause a change in state of the shape memory material (e.g., a change in length). The shape memory material may be attached directly to the battery 109, or a conductor could be coupled between the battery and the shape memory material for conducting power to the shape memory material. The change in state actuates the lock mechanism 117 which disengages the engagement member from the lower rod 102 to thereby provide access to the lower rod.

In some embodiments, the electronic lock mechanism 117 may further include a biasing member (e.g., a spring) that is configured to return the engagement member to a locked configuration on the lower rod 102. Thus, actuation of the shape memory material 114 may be configured to overcome the biasing force to thereby release the lower rod 102. The spring would then return the engagement member of the lock mechanism 117 into engagement with the lower rod 102 when the shape memory material 114 no longer actuates the lock mechanism. The locking hook 100 may be configured to automatically lock upon manually engaging the engagement member of the lock mechanism 117 with the lower rod 102. For example, upon engagement of the forward end portion 108 with the lower rod 102, the engagement member of the lock mechanism 117 may be biased into engagement with the lower rod.

In addition, the locking hook 100 may further include an actuator 119 that is configured to bias the upper rod 103 towards the display surface 120. For instance, the actuator 119 could be a coiled spring that is configured to unwind as the upper rod 103 of the locking hook 100 is displaced outwardly from the display surface 120. The actuator 119 is biased to return to its coiled configuration when the force displacing the upper rod 103 (and therefore the forward end portion 108 of the locking hook 100) away from the display surface 120 is removed. The bias of the actuator 119 in turn biases the locking hook 100 towards the display surface 120 and a locked configuration.

FIGS. 12 and 13 illustrate an embodiment of a locking hook 150 in use. As shown in FIG. 12, a sales associate may utilize an electronic device 14, for example a Smartphone or mobile telephone, having NFC functionality to interact with a locking hook 150 having an electronic lock 112, as previously described. FIG. 13 shows that the locking hook 150 has been unlocked following communication between the electronic device 14 and the NFC tag 113 of the electronic lock 112. An authorized sales associate is then able to remove items of merchandise from the lower rod 102 of the locking hook 150 while the engagement member of the electronic lock mechanism 117 is disengaged from the notch 116 of the lower rod and the forward end portion 108 is displaced away from the free end of the lower rod.

The foregoing has described one or more embodiments of a merchandise security device, system and method for protecting an item of merchandise from theft. Embodiments of a merchandise security device and system have been shown and described herein for purposes of illustrating and enabling the best mode of the invention. Those of ordinary skill in the art, however, will readily understand and appreciate that numerous variations and modifications of the invention may be made without departing from the spirit and scope thereof. Accordingly, all such variations and modifications are intended to be encompassed by the appended claims.

That which is claimed is:

1. A merchandise security device for protecting an item of merchandise from theft, the merchandise security device comprising:
an electronic lock configured to be locked or unlocked and to be secured to a merchandise fixture, the electronic lock comprising at least one near field communication (“NFC”) tag,
wherein the NFC tag is configured to communicate with an electronic device comprising at least one NFC tag to at least unlock the electronic lock.

2. The merchandise security device of claim 1, wherein the electronic lock comprises a lock mechanism configured to be actuated between a locked position and an unlocked position in response to communication between the at least one NFC tag of the electronic lock and the at least one NFC tag of the electronic device.

3. The merchandise security device of claim 2, further comprising a processor in communication with a switch, the processor being configured to actuate the switch to thereby actuate the lock mechanism in response to communication with the at least one NFC tag of the electronic device.

4. The merchandise security device of claim 2, wherein the lock mechanism comprises an actuator that is configured to extend and retract in response to communication between the at least one NFC tag of the electronic lock and the at least one NFC tag of the electronic device.

5. The merchandise security device of claim 1, wherein the electronic lock further comprises a source of electrical power.

6. The merchandise security device of claim 1, further comprising a proximity mechanism configured to detect the position of the electronic lock relative to the merchandise fixture.

7. The merchandise security device of claim 6, wherein the proximity mechanism comprises a reed switch or a Hall effect sensor.

8. A merchandise security system comprising:
an electronic lock configured to be locked or unlocked and to be secured to a merchandise fixture, the electronic lock comprising at least one near field communication (“NFC”) tag; and
an electronic device comprising at least one NFC tag, wherein the at least one NFC tag of the electronic lock is configured to communicate with the at least one NFC tag of the electronic device to at least unlock the electronic lock.

9. The merchandise security system of claim 8, wherein the electronic device comprises a mobile phone or a Smartphone.

10. The merchandise security system of claim 8, wherein the electronic lock comprises a drawer lock or a locking hook.

11. The merchandise security system of claim 8, wherein the electronic lock comprises a lock mechanism configured to be actuated between a locked position and an unlocked position in response to communication between the at least one NFC tag of the electronic lock and the at least one NFC tag of the electronic device.

12. The merchandise security system of claim 11, wherein the electronic lock comprises a processor in communication with a switch, the processor being configured to actuate the switch to thereby actuate the lock mechanism in response to communication with the at least one NFC tag of the electronic device.

13. The merchandise security system of claim 8, wherein the electronic lock further comprises a source of electrical power.

14. The merchandise security system of claim 8, further comprising a proximity mechanism configured to detect the position of the electronic lock relative to the merchandise fixture.

15. A method for protecting merchandise from theft, the method comprising:
attaching an electronic lock to a merchandise fixture, the electronic lock configured to be locked or unlocked and comprising at least one near field communication (“NFC”) tag; and
actuating an electronic key comprising at least one NFC tag such that the at least one NFC tag of the electronic lock communicates with the at least one NFC tag of the electronic device to at least unlock the electronic lock.
